(19) United States
(12) Patent Application Publication
(10) Pub. No.: US 2013/0076472 A1
(43) Pub. Date: Mar. 28, 2013

(54) Super-thin Filter Structure

(71) Applicant: YUJING TECHNOLOGY CO., LTD, New Taipei City (TW)

(72) Inventor: Cheng-Yu Pan, New Taipei City (TW)

(73) Assignee: YUJING TECHNOLOGY CO., LTD, New Taipei City (TW)

(21) Appl. No.: 13/624,989

(22) Filed: Sep. 24, 2012

(30) Foreign Application Priority Data
Sep. 23, 2011 (TW) 100217872

(51) Int. Cl. H01F 27/28

(52) U.S. Cl. 336/195

(57) ABSTRACT

A super-thin filter structure mainly has a channel furnished in the iron core with a penetrating hole furnished in the middle section thereof; a truncated angle parts is furnished at the end angles of the iron core; a containing concave part for containing the iron core is furnished and a center seat having a penetrating hole is furnished at the center thereof for placing into the penetrating hole of the iron core; a wire-guiding channels is also furnished at the bottom of the base; an upper cover is placed into the channel, and a center salient part having a penetrating hole is capable of placing into the penetrating hole and touching the center seat making the upper cover to clip the iron core in coordination with the base; a wire-guiding channels together with the wire-guiding channels is capable of simultaneously providing the winding of a coil.

### BACKGROUND OF THE INVENTION

1. Field of the Invention

The invention relates to a super-thin filter structure, and more particularly, to a super-thin filter structure that is easy to assemble and perform working, and is industrial applicable in a wide range.

2. Description of the Prior Art

Since in the process of transmission, the general power or electronic signal has to pass through a media with inconsistent impedance that causes various interferences, the power or electronic signal after the interference and attenuation will generate various noises and affect the normal performance of the computer and various electronic products. Therefore, various filters capable of preventing the electromagnetic interference (EMI) and filtering the noise are widely utilized in various electrical facilities such as computer, television, and audio-video devices.

For example, a utility model patent no. M401845 “Multi-function Power Source Filter” of the patent publication of Republic of China that includes a positioning structure, a plurality of bobbins, a first coil, and a second coil; the positioning structure has a plurality of installation spaces and a plurality of conductance leads positioned at the periphery of the positioning structure. Each of these bobbins securing respectively in the installation spaces has a fist axis part and a second axis part. The first coil spans across different bobbins and winds around the first axis part while the second coil spans across different bobbins and winds around the second axis part, thereafter, combines together to be connected to these seats through the first coil and the second coil. In this way, the applicable power or current flow of a filter can be amplified by winding a relatively longer or larger in wire diameter through the first axis part and the second axis part of the plurality of bobbins to meet the requirements of electric facility with large power and large current. However, this kind of structure has the following shortcomings in application:
1. As the first and second axis parts on the bobbin has circular cross-section, the wire-winding operator needs to take more time to sort out repeatedly that causes disturbance in production and working if the wire is not tightly drawn due to negligence making the previous winding wire loose in great amount during the process of coil winding.
2. As the wire-winding channel at the periphery of the bobbin is a single space disposition, the wire-winding operation can start only from an end. Although the wire can be supplied and guided from a reel during the winding process, the reel and excessive stretching of the wire can still cause inconvenience during the winding operation.
3. As each of the conductance lead of the positioning structure is furnished at the periphery and protruded outward, it is not conducive to the design trend for diminishing geometries and compact structure of the product.

Another example is a utility model patent no. M400160 “Super-thin Type of LED Driven Multi-function Common Mode Inductance Power Source Filter” of the patent publication of Republic of China. It includes a base and a magnetic core carried by the base where the magnetic core has two parallel bases and two terminals that are connected respectively to the two wire-winding posts at the bases. Its feature lies in the fact that the wire-winding post includes two first surfaces which are mirror-symmetrical with respect to the center of the wire-winding post and a wire-winding post thickness defined by the fact that the width of the wire-winding post along the first axis is greater than the space between the outer edges of the two first surfaces. Through the above-mentioned technical features, the wire-winding post is set to be in elliptical or rectangular shape which makes the type of the wire-winding post form a shape that it is slim in one dimension while narrow in another dimension. In this way, the thickness of the wire-winding post can be compacted further, making the overall thickness of the power source filter diminish and vacate more space for the product, thereby, the size of the product can be designed to be further diminished.

Although the wire-winding posts of the magnetic core structure of the patent has the shape with non-circular cross-section which is capable of improving the shortcoming that if the wire is not tightly drawn due to negligence, it will make the previous winding wire loose in great amount during the process of coil winding, it inevitably has the occurrence of the above-mentioned relevant shortcomings since it still has the design of a single wire channels and protrudent leads.

Therefore, just how to resolve the above-mentioned problems has become an urgent issue to seek for an improving program in the industry.

### SUMMARY OF THE INVENTION

In light of the above-mentioned disadvantages of the prior art, the invention provides a super-thin filter structure that is capable of overcoming the shortcomings of the prior art, satisfying the requirements of the industry, as well as improving the competitiveness in the market. It aims to ameliorate at least some of the disadvantages of the prior art or to provide a useful alternative.

The primary objective of the invention is to provide a super-thin filter structure in which, under the premise of basic thinner design to lower the height of the filter structure, a partitioning flange is furnished in the middle section of wire-guiding channels for wire-winding to provide a starting position for the coil to wind from the center toward both sides, thereby to simplify the wire-winding operation.

The secondary objective of the invention is to provide a super-thin filter structure in which a truncated angle part is furnished respectively at each end angle of the iron core, and the truncated angle parts can correspondently provide a base with a wire-guiding post to efficiently save the occupied space.

The third objective of the invention is to provide a super-thin filter structure in which each wire-guiding channel of the lead frame is flat and thin in cross-sectional shape such that if the wire is not tightly drawn due to negligence, the previous winding wire will not loose in great amount during the process of coil winding, thereby the subsequent sorting-out time and spirit can be lowered.

To achieve the above-mentioned objective, a super-thin filter structure of the invention has a channel furnished in the iron core with a penetrating hole furnished in the middle section thereof; a truncated angle parts is furnished at the end angles of the iron core; a containing concave part for containing the iron core is furnished and a center seat having a penetrating hole is furnished at the center thereof for placing into the penetrating hole of the iron core; a wire-guiding channels is also furnished at the bottom of the base; an upper cover is placed into the channel, and a center salient part having a penetrating hole is capable of placing into the penetrating hole and touching the center seat making the upper cover to clip the iron core in coordination with the base; a wire-guiding channels together with the wire-guiding channels is capable of simultaneously providing the winding of a coil.

In accordance with the above-mentioned structure, protrudent partitioning flanges are furnished in the middle section of the wire-guiding channels to be used as the starting positions for winding the wire of a coil from the center toward both sides.

In accordance with the above-mentioned structure, a protrudent stopping plate is furnished at the periphery of the containing concave part (11) of the base.

In accordance with the above-mentioned structure, two oppositely disposed positioning indentations are furnished at the stopping plates.

In accordance with the above-mentioned structure, a channel at the iron core is furnished in the direction of the extension of the corresponding two oppositely disposed positioning indentations of the base

In accordance with the above-mentioned structure, an engaging part is furnished at the periphery of the penetrating hole and an engaged part is furnished at the periphery of the center salient part for connecting to the engaging part

In accordance with the above-mentioned structure, the engaging part and the engaged part can also be a circumferential concave step, circumferential convex step that are mutually embedded.

In accordance with the above-mentioned structure, a wire-guiding post at the base is furnished correspondently to each of the truncated angle parts of the iron core for connecting to the coils.

The accomplishment of this and other objectives of the invention will become apparent from the following description and its accompanying drawings of which:

### BRIEF DESCRIPTION OF THE DRAWINGS

FIG. 1 is an isometric exploded view of the super-thin filter structure of the invention.

FIG. 2 is an isometric view of the super-thin filter structure combining the top cap with the base of the invention.

FIG. 3 is an isometric view of the super-thin filter structure combining the top cap and the iron core with the base of the invention.

FIG. 4 is an isometric view of the overall assembled super-thin filter structure of the invention.

### DETAILED DESCRIPTION OF THE PREFERRED EMBODIMENT

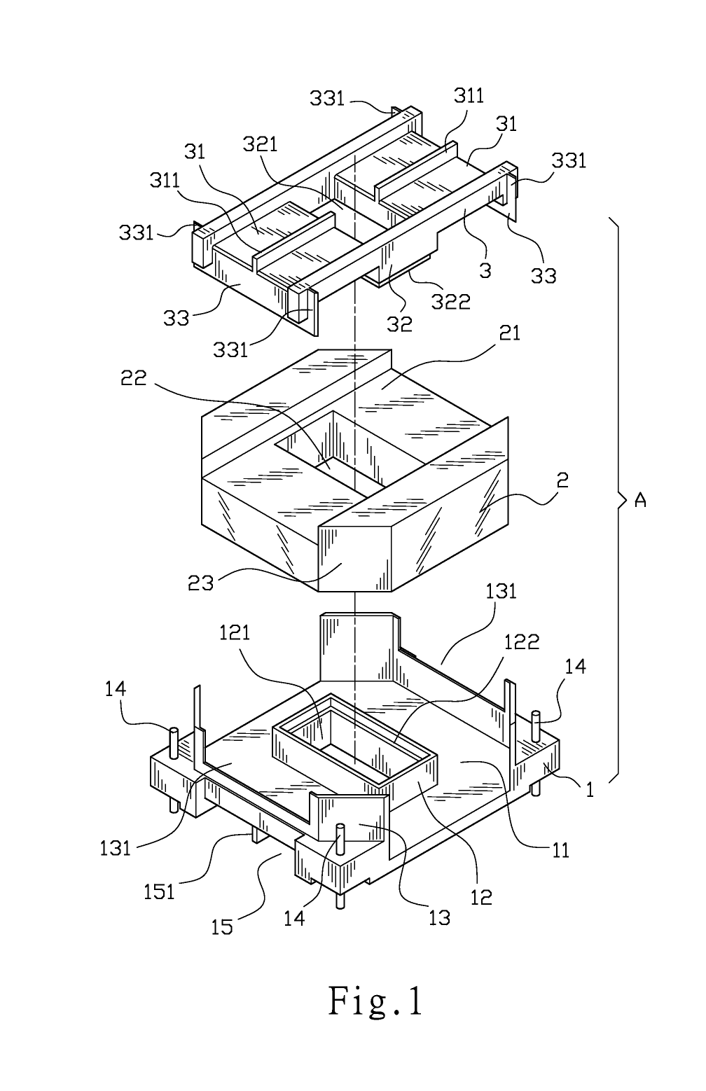

FIG. 1 is an isometric exploded view of the super-thin filter structure of the invention. As shown in FIG. 1, the super-thin filter structure of the invention includes an iron core (2) and a lead frame (A). The lead frame (A) consists of a base (1) and an upper cover (3). The iron core (2) having a channel (21) at the top center thereof has a penetrating hole (22) at the center of the channel (21) making both sides of the channel (21) become two flat and thin cross-sectional structures. What is more, truncated angle parts (23) are formed at the four end angles of the iron core (2). The base (1) has a containing concave part (11) for containing the iron core (2) where the containing concave part (11) has a center seat (12) at the center of the containing concave part (11) and is corresponding to the penetrating hole (22) of the iron core (2). A penetrating hole (121) is also provided at the center of the center seat (12).

As shown again in FIG. 1, an engaging part (122) (which can also be a circumferential concave step) is furnished at the periphery of the penetrating hole (121). What is more, a protrudent stopping plate (13) corresponding to the truncated angle parts (23) of the iron core (2) is also furnished at each end angle of the containing concave part (11) of the base (1). Depending on the needs, a wire-guiding post (14) is furnished adjacent to each of the truncated angle parts (23). Moreover, two oppositely disposed positioning indentations (131) are furnished to be correspondingly connected to the channel (21) of the iron core (2). In addition, a wire-guiding channel (15) with at least a protrudent partitioning flange (151) disposed in the middle section thereof is furnished beneath the base (1) by extending from the positioning indentations (131).

As shown also in FIG. 1, the upper cover (3) is engaged in the two positioning indentations (131) of the base (1). A center salient part (32) having a penetrating hole (321) is furnished at the center of the upper cover (3) and is corresponding to the penetrating hole (22) of the iron core (2) wherein the center salient part (32) has an engaged part (322) (which can also be a circumferential convex step) furnished at the periphery of the center salient part (32). Moreover, a lead channel (31) with at least a protrudent partitioning flange (311) disposed in the middle section thereof is furnished on both side of the penetrating hole (321) of the upper cover (3). Moreover, a check plate (33) corresponding to the adjacent outer side of the positioning indentations (131) of the base (1) is furnished respectively on each side of the upper cover (3) wherein the check plate (33) has a side wing part (331) furnished by outward extending from both ends thereof.

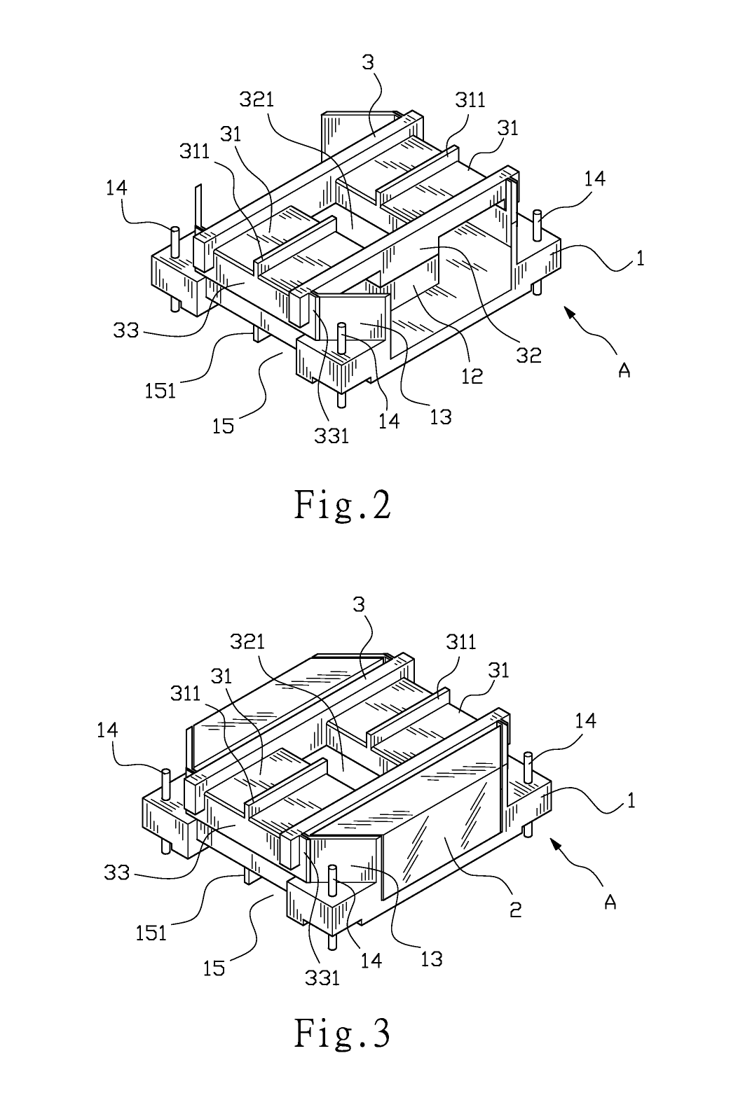

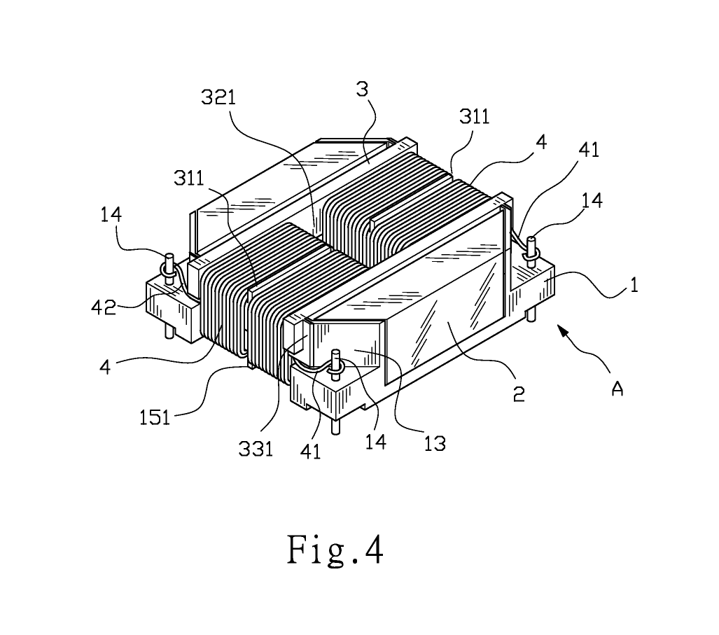

FIG. 2 is an isometric view of the super-thin filter structure combining the top cap with the base of the invention; FIG. 3 is an isometric view of the super-thin filter structure combining the top cap and the iron core with the base of the invention; and FIG. 4 is an isometric view of the overall assembled super-thin filter structure of the invention. As shown in FIG. 2, FIG. 3, and FIG. 4, when it comes to assembling, the iron core (2) is placed in the containing concave part (11) of the base (1) with the center seat (12) of the base (1) fitting into the penetrating hole (22) of the iron core (2) to be in position. The upper cover (3) is placed into the channel (21) of the iron core (2) with the center salient part (32) fitting into the penetrating hole (22) of the iron core (2) and in the same time with the engaged part (322) (or circumferential flange) fitting into the engaging part (122) (or circumferential flange) of the base (1), also with the side wing parts (331) of the check plate (33) placing outside of the positioning indentations (131) of the base (1). In this way, the upper cover (3) and the base (1) are capable of clipping the iron core (2) to form stable positioning. Afterward, one can have the partitioning flanges (151), (311) as starting points to wind wires around the partitioning flange (151), (311) in the wire-guiding channels (15), (31). Finally, wire end portions (41), (42) are tied around the wire-guiding posts (14) to form coils (4).

In conclusion, since one can have the partitioning flanges (151), (311) as starting points to wind wires around the two sides, the wires is capable of retaining a relatively shorter length beforehand to facilitate the simplifying winding operation, and the upper cover (3) is covered on the base (1) to form the lead frame (A), the super-thin filter structure of the invention is simple and convenient in assembling work. In the mean time, by making use of the iron core (2) on the two sides of the penetrating hole (22), the super-thin filter structure of the invention is capable of forming a structural design of a long, flat, and thin in cross-sectional shape that can spend less time and effort in post-processing work since once the wire-winding operator is loosing in winding, the already wound wire so far won't become loose in great amount, thereby the super-thin filter structure of the invention is capable of making the wire winding work more efficient. What is more, since the wire-guiding posts (14) at the base (1) are furnished at the truncated angle parts (23) of the iron core (2) without protruding out of the side surfaces of the base (1), the super-thin filter structure of the invention is capable of avoiding to occupy excessive larger space, thereby can improve the overall space utilization. Consequently, the super-thin filter structure of the invention substantially has the efficacies of being compact in volume, easy ino assembling work, thereby possesses the patentability of an invention.

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. A super-thin filter structure, comprising:
an iron core having a penetrating hole and truncated angles parts formed at the four end angles thereof;
a base having a containing concave part for containing the iron core where the containing concave part has a center seat at the center of the containing concave part that is capable of placing into the penetrating hole, and having wire-guiding channels on the opposite side of the containing concave part;
an upper cover furnished above the containing concave part, where the upper cover has a center salient part for placing into the penetrating hole of the iron core and touching the center seat of the base making the upper cover capable of clipping the iron core in association with base; wire-guiding channels are also furnished at the bottom side of the upper cover to be in association with the wire-guiding channels for providing a structure to wind a coil.

2. The super-thin filter structure as claimed in claim 1, wherein protrudent partitioning flanges are furnished in the middle section of the wire-guiding channels to be used as the starting positions for winding the wire of a coil from the center toward both sides.

3. The super-thin filter structure as claimed in claim 1 or claim 2, wherein a protrudent stopping plate corresponding to the truncated angle parts of the iron core is furnished at each end angle of the containing concave part of the base and a wire-guiding post at the base is furnished correspondently to each of the truncated angle parts of the iron core for connecting to the coils.
a wire-guiding post is also furnished adjacent to each of the truncated angle parts for connecting to the coils.

4. The super-thin filter structure as claimed in claim 3, wherein two oppositely disposed positioning indentations are furnished at the stopping plates to be correspondingly connected to the channel of the iron core.

5. The super-thin filter structure as claimed in claim 4, wherein a channel at the iron core is furnished in the direction of the extension of the corresponding two oppositely disposed positioning indentations of the base.

6. The super-thin filter structure as claimed in claim 1 or claim 2, wherein an engaging part is furnished at the periphery of the penetrating hole and an engaged part is furnished at the periphery of the center salient part for connecting to the engaging part.

7. The super-thin filter structure as claimed in claim 3, wherein an engaging part is furnished at the periphery of the penetrating hole and an engaged part is furnished at the periphery of the center salient part for connecting to the engaging part.

8. The super-thin filter structure as claimed in claim 4, wherein an engaging part is furnished at the periphery of the penetrating hole and an engaged part is furnished at the periphery of the center salient part for connecting to the engaging part and the engaging part and the engaged part can also be a circumferential concave step, circumferential convex step that are mutually embedded.

9. The super-thin filter structure as claimed in claim 6, wherein the engaging part) and the engaged part can also be a circumferential concave step, circumferential convex step that are mutually embedded.

10. The super-thin filter structure as claimed in claim 7, wherein the engaging part and the engaged part can also be a circumferential concave step, circumferential convex step that are mutually embedded.
